(19) United States
(12) Patent Application Publication
(10) Pub. No.: US 2008/0229101 A1
(43) Pub. Date: Sep. 18, 2008

(54) AUTHENTICATED CORRESPONDENT DATABASE

(75) Inventor: Michael Allen Thomas, San Francisco, CA (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: CISCO TECHNOLOGY, INC., San Jose, CA (US)

(21) Appl. No.: 11/686,770

(22) Filed: Mar. 15, 2007

(51) Int. Cl. H04L 9/00

(52) U.S. Cl. 713/168

(57) ABSTRACT

A system that can intelligently drive down false positive rates with regard to identification and/or classification of spam correspondence is disclosed. Authentication information from sending domains can be stored and used to establish confidence and drive down the false positives related to acceptance and/or classification of communications. A correspondent database of known correspondents can be constructed using the authenticated information. Accordingly, decisions (e.g., white and black list) can be better informed by employing relationship and correspondent communication pattern data which is maintained within the correspondent database.

### TECHNICAL FIELD

The subject disclosure relates generally to electronic communication and more particularly to authenticating a sender to secure electronic communication and information transfer related to a variety of modalities.

### BACKGROUND

Enterprises employ a vast number of protocols for internal and/or external communications and information transfer in order to ensure reliability, security and compliance with particular policies. For example, internal and/or external communications and information transfer can include, but are not limited to instant messaging (IM), electronic mail (email), Internet Protocol (IP) telephony, web mail, web-browsing, text messaging over a network of two or more computers (or network connectable, processor-based devices), and the like. These electronic communication media are popular as they provide inexpensive, easy, point-to-point communication that is less intrusive than traditional techniques and/or disparate non-electronic communications. There is an abundance of other benefits, for example, IM is an electronic communication that easily enables one-to-many communication. Additionally, there is no need to synchronize participants and the content can be planned more easily, among other things. Unfortunately, these media have adversaries and/or protocols that threaten the convenience of and confidence in their use, namely spam, viruses, malware, etc.

A variety of systems and techniques have been developed and employed to combat spam and other forms of malicious messages related to electronic communication media. With an increase in malicious activity involving spam, viruses, malware, and the like, enterprises are continuously searching for efficient techniques to secure networks and respective data communications associated therewith. Thus, conventional techniques (e.g., content-based filters, IP address-based filters, etc.) are becoming ineffective in recognizing and blocking disguised spam messages in relation to electronic communications. The integrity of enterprises and data communications is imperative to success in which improvements are necessary to ensure security and/or protective techniques are less vulnerable, stronger, and more difficult to penetrate.

### BRIEF DESCRIPTION OF THE DRAWINGS

FIG. 1 illustrates a block diagram of an example system that employs a correspondent database to drive down false positives related to spam classification.

FIG. 2 illustrates an example flow chart of procedures that facilitate establishment of a correspondent database in accordance with an aspect of the specification.

FIG. 3 illustrates an example flow chart of procedures that facilitate employing the correspondent database to intelligently classify spam.

FIG. 4 illustrates an example block diagram of a system that includes a message filter component in accordance with an embodiment.

FIG. 5 illustrates an example block diagram of a message filter component in accordance with an aspect of the disclosure.

FIG. 6 illustrates an example block diagram that employs a database generation component to establish a correspondent database in accordance with an aspect.

FIG. 7 illustrates a block diagram of a computer operable to execute the disclosed architecture.

FIG. 8 illustrates a schematic block diagram of an exemplary computing environment in accordance with the subject specification.

### DESCRIPTION

### Overview

The following presents a simplified overview in order to provide a basic understanding of some embodiments described herein. This is not an extensive overview of the disclosed embodiments. It is intended to neither identify key or critical elements of the specification nor to delineate the scope of that subject matter. Its sole purpose is to present some concepts of the specification in a simplified form as a prelude to the more detailed description of example embodiments that is presented later.

The specification relates to a use of authentication information from sending domains to establish confidence and drive down false positives related to acceptance and/or classification of communications. It is to be understood that a ‘false positive’ refers to an erroneous identification of a threat or dangerous condition that turns out to be harmless. By using the authenticated information, a receiving domain can construct a database of known correspondents from which decisions (e.g., white and black list) can be better informed. Further, this authenticated information can be used directly to bias filtering heuristics.

The following description and the annexed drawings set forth in detail certain illustrative embodiments of the specification. These embodiments may be indicative, however, of but a few of the various ways in which the principles of the specification may be employed and the specification is intended to include many and/or all such embodiments and their equivalents. Other advantages and novel features of the specification will become apparent from the following description of example embodiments when considered in conjunction with the drawings.

### DESCRIPTION OF EXAMPLE EMBODIMENTS

The specification is now described with reference to the drawings, wherein like reference numerals are used to refer to like elements throughout. In the following description, for purposes of explanation, numerous specific details are set forth in order to provide a thorough understanding of the subject specification. It may be evident, however, that the specification can be practiced without these specific details. In other instances, well-known structures and devices are shown in block diagram form in order to facilitate describing the specification.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

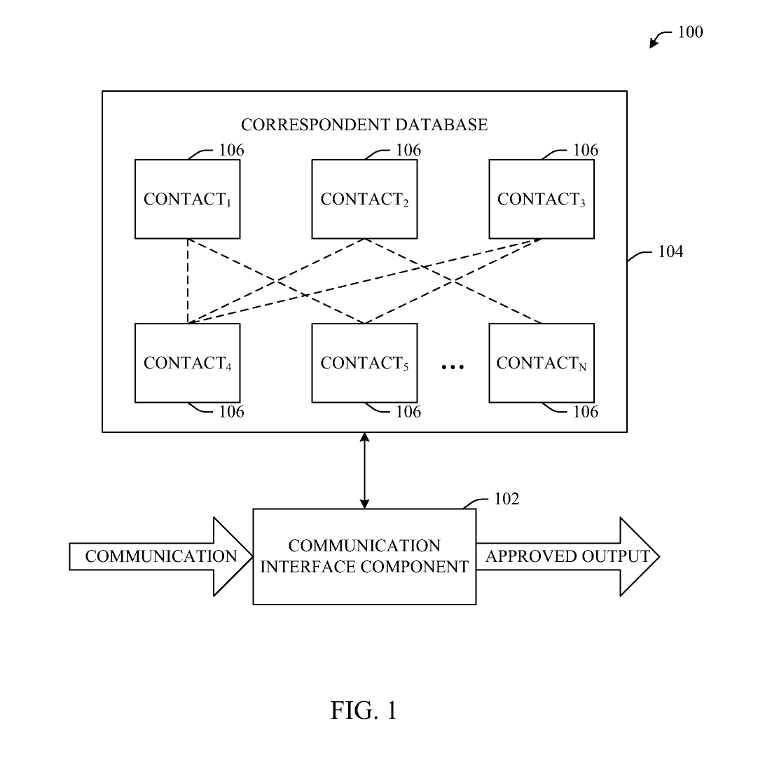

Referring initially to the drawings, FIG. 1 illustrates a system 100 that includes a communication interface component 102 and a correspondent database 104 that employs relationship information to establish determination with regard to acceptance and/or denial of communication. The correspondent database 104 can be employed to house relationship information associated with 1 to N contacts. As shown in FIG. 1, the 1 to N correspondents, or contacts, can be referred to individually or collectively as contact 106.

As described above, without correspondent information (e.g., authentication and relationship information), it would be very easy to look at an authenticated domain and its current behavior and falsely decide that it was a good candidate for blacklisting. A correspondent database 104 may reveal that, despite the apparent misbehavior, biasing toward ‘junk’ or spam would be unwise. Likewise, with correspondent information, the domains that are sending legitimate correspondence will become immediately apparent after some training, and their correspondence can thus be biased toward delivery, lowering the false positive rate. It will be understood that false positives are very detrimental to the electronic communication industry.

Thus, being able to give strong assurance that filters are not discarding legitimate mail, especially from well known correspondents, is an advantage. The correspondent database 104 of system 100 can be trained or learn over time, characteristics that correspond to a contact 106. Subsequently, this database of contact information can be used to make intelligent decisions with regard to accepting or denying (e.g., white or black listing) a sender based upon most any criteria of the sender including, but not limited to, sender domain, sender relationships, sender history, sender context, receiver context or the like (all of which can be included within the contact 106 information).

With continued reference to FIG. 1, when a communication is received by the communication interface component 102, an analysis can be performed that determines criteria and information related to the sender. This information can be employed to establish whether or not to accept a communication. As will be described in greater detail infra, once the sender identity is authenticated, the correspondent database 104 can be employed to make a determination whether to accept or deny communication and/or data from the sender. In one aspect, relationships are analyzed, for example, degrees of separation from the target recipient and/or trusted contacts is used to increase probabilities and inherently drive down false positive rates. As used herein, ‘degrees of separation’ refers to the number of hops necessary to reach an individual through a network of individuals. In other words, it represents the number of links (or intermediaries) in a chain of acquaintances between two individuals. It is to be understood that ‘degrees of separation’ refers to a theory that that anyone on the planet can be connected to any other person on the planet through a chain of acquaintances that has no more than a specified number of intermediaries, for example five intermediaries for ‘six degrees of separation.”.

In the fight against spam, conventional spam filters make a tradeoff between the false positive rate and the false negative rate. It is to be understood that a ‘false negative’ can refer to an erroneous identification of a benign condition that turns out to be harmful. That is, the more aggressive a spam filter becomes, the higher the likelihood that the filter will classify legitimate email as spam, e.g., false positive. Most often, those that deploy anti-spam software are rightfully concerned about the false positive rate as it is extremely difficult to measure. Moreover, the consequences (e.g., missed sales, missed emergency, missed communication, etc.) could be disastrous and extremely expensive.

In order to reduce the false positive rate, it is useful to know with whom a user or an organization regularly corresponds. Thus, informed decisions can be made about a particular message by utilizing this compilation of relationship information (e.g., correspondent database 104). One difficulty is that mail is most often unauthenticated so that it is trivial for an attacker to gain advantage by simply spoofing the source of the email as somebody that the receiver is likely to consider a good actor. In other words, without authentication, an attacker can merely pose as a trusted source thereby tricking a user into accepting a communication by thinking that it is received from a trusted source.

For small ‘white lists’, such as those used in mail reader software, there is some amount of security in the ‘obscurity’ of the content of an individual user's address book. For a larger aggregate, such as an organization, however, the ‘obscurity’ is not very obscure. Therefore, it would be relatively easy for the attacker to choose names in order to bypass conventional filters.

Here, the communication interface component 102 can authenticate a communication received and thereafter employ the correspondent database 104 to accept or deny the communication. This determination can be made based upon a user (or otherwise) defined policy, for example, receive communications from authenticated senders with X degrees of separation from the recipient. In other words, so long as an incoming message can be authenticated as coming from a particular source (e.g., user, domain, etc.), this authenticated source information (e.g., identity) can be employed as a basis of creating a correspondent tuple (associated with contact 106) within the correspondent database 104. It is to be understood that a ‘tuple’ most often refers to a record or a row in a database, such as a relational database.

A correspondent tuple can then be updated each time a new message or communication is received. It is to be understood that the update need not occur upon receipt. For example, an update can occur in accordance with a batch process. Further, it is to be understood that an update need to occur at all, if not necessary in view of the correspondence.

Continuing with the example above, this update enables tracking of the use pattern of those correspondents (106). It is to be understood that, in the case of spam, the use pattern is often described as many pieces of email received from a given source with little or no reverse correspondence originating from the target domain. For legitimate correspondence between domains or users, one could expect a more ‘balanced’ use pattern. That is, that the number of messages sent from one domain is approximately equal to the number of messages sent from the other domain. It is to be understood that there can be numerous metrics that are indicative of goodness and badness with regard to communications.

In this example and given both of these calculation/counting properties, both ‘white’ and ‘black’ biasing for receivers can be employed. White biasing can be calculated by looking for users or domains with balanced communication of a statistically significant sample. It is to be understood that this white/black listing may also be accomplished in conjunction with other metrics such as accumulated spam score experience, etc.

Correspondence between two domains typically falls into one of three use patterns. A first category relates to domains that are highly correlated with desired communication with the occasional outlier due to, say, a user's machine being infected. A second category relates to domains that are highly correlated with undesirable communication. Finally, a third category can relate to domains with a mix of wanted and unwanted communication, for example commercial mail services or domains for which there is little or no experience. It is to be understood that these categories are provided to add perspective to the described embodiments and are not intended to limit the scope of the embodiments in any way.

The advent of domain based identity, especially for email in the form of Domain Keys Identified Mail (DKIM), gives the ability to reliably and automatically establish whether one domain is communicating with another as well as to determine the ‘balance’ of the communication between the domains. DKIM is a method of email authentication which focuses on end-to-end integrity from a signing to a verifying mail transfer agent. It will be appreciated that, most often, the signing mail transfer agent acts on behalf of the sender and the verifying mail transfer agent acts on behalf of the receiver.

The DKIM protocol is just one example of an authentication mechanism that can be used in accordance with aspects of the specification. Alternative authentication mechanisms can be employed in connection with email as well as other communication protocols/modalities without departing from the spirit and/or scope of the specification. For example, other known protocols for authentication (e.g., SPF, PGP/SMIME) that are employed in connection with communication modalities can be used to in alternative embodiments. By way of example, authentication mechanisms, other than DKIM described above, can be used in connection with email, text messaging, voice communications, instant messaging sessions or the like.

Furthermore, it is to be understood that authentication need not be explicit. Rather, implicit authentication mechanisms can be employed without departing from the scope of this specification. An example of implicit authentication can be realized as when a user is operating behind a corporate VPN (virtual private network). Accordingly, communications from other users behind the VPN can be implicitly authenticated. As such, these alternatives are to be included within the scope of this specification and claims appended hereto.

As described above, a contact 106 tracking can be employed via the communication interface component 102 which can update corresponding tuples in the correspondent database 104. Continuing with the example from above, domains with balanced communication are highly likely to be correlated with the first category described supra (e.g., desired communication sources). Domains with this balanced characteristic would be good candidates for white listing and/or biasing toward normal delivery.

Similarly, domains with unbalanced communication may be associated with the second category above, though further input would be helpful to accurately categorize a domain, such as cumulative spam score averages, number of virus transmissions, etc. One key idea here is that compiling and maintaining an authentication correspondence database 104 can allow administrators (and other entities) to know who the known correspondents (106) are in their domain so as to drive down false positives. Additionally, this correspondent database 104 can produce helpful information when evaluating whether a seemingly misbehaving domain actually has some following or relationship within the domain before making some sort of mitigation decision. This informed and intelligent decision process can inherently drive down false positives while protecting the target domain as a whole.

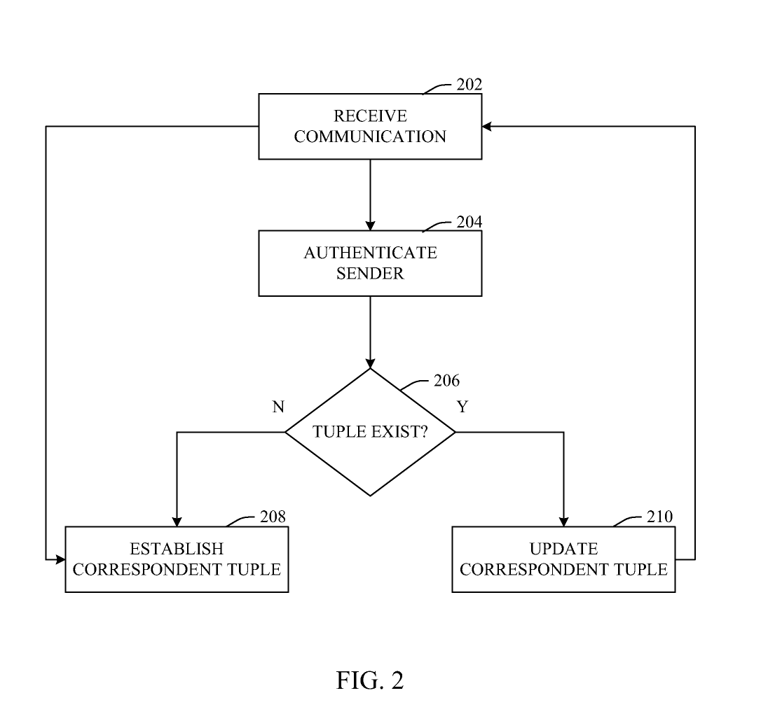

FIG. 2 illustrates a methodology of establishing a correspondent database (e.g., 104 of FIG. 1) in accordance with an aspect of the specification. While, for purposes of simplicity of explanation, the one or more methodologies shown herein, e.g., in the form of a flow chart, are shown and described as a series of acts, it is to be understood and appreciated that the subject specification is not limited by the order of acts, as some acts may, in accordance with the specification, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the specification.

Initially, at 202, an electronic communication can be received from a sending source. The communication can represent most any type of information transfer including, but not limited to, email, instant message (IM), text message, VOIP (voice-over-Internet-protocol) communication or the like. Additionally, it is to be appreciated that the message can contain audio, video, text or any combination thereof. For example, a video call that includes both audible as well as visual information can be addressed in accordance with aspects of this specification.

Next, at 204, the sender source (e.g., sender domain) is authenticated. As described above, most any authentication mechanism can be employed, for example, DKIM. Once the sender source is authenticated, at 206, a determination can be made to identify if a tuple exists in a correspondent database. In other words, a search can be employed of a correspondent database to determine if a tuple was previously generated for a particular sender source.

If a tuple does not exist, at 208, a tuple is generated that corresponds to the authenticated sender source. As will be understood, the tuple can include most any information that identifies a sender, for example, identity, domain information, relationships to other correspondents or contacts, spam rating, traffic/message counter information, etc. Alternatively, if a corresponding tuple already exists, at 210, the tuple can be updated with additional and/or modified information. By way of example, relationship information can be updated with regard to the sender correspondent.

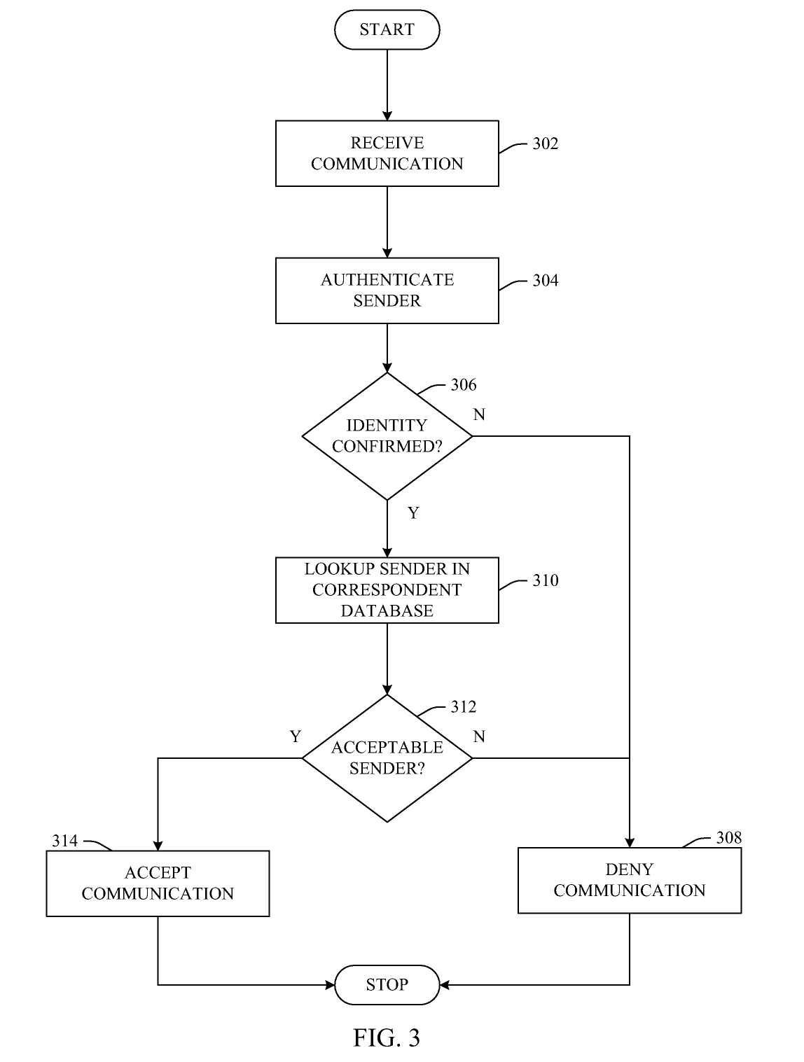

Referring now to FIG. 3, there is illustrated a methodology of employing a correspondent database to accept or deny data received from a sender in accordance with an embodiment of the specification. At 302, a communication is received, for example, an email, IM, text message, VOIP communication or the like. Upon receipt, the sender can be authenticated at 304 using most any suitable authentication, including but not limited to the DKIM protocol.

At 306, a decision can be made to determine if identity of the sender is confirmed. If the identity is not confirmed by the authentication process at 304, the communication is denied at 308. Alternatively, if the authentication is successful, the sender is looked up in a correspondent database at 310.

As described above, the correspondent database can be employed to maintain information and criteria related to a sender. By way of example, the database can include a number of tuples that define criteria such as sender identity, alternative identities, domain, spam rating, relationships, etc. It is to be understood that the correspondent database can be located in a single location or alternatively can be distributed throughout a number of locations without departing from the spirit and/or scope of the innovation.

Based upon information found in the correspondent database, a determination can be made at 312 that identifies if a sender is accepted or denied. If not acceptable, the communication is denied at 308. On the other hand, if the sender is deemed up to standard, the communication is accepted at 314. It will be understood that the methodology described herein can drive down false positives by increasing probabilities related to safe communication. In other words, criteria maintained within the correspondent database can be employed to increase probabilities associated with correctly categorizing communication as safe or unsafe (e.g., spam or non-spam). As described supra, it is to be understood that other metrics exist and can be employed in alternative aspects with regard to goodness and badness determinations.

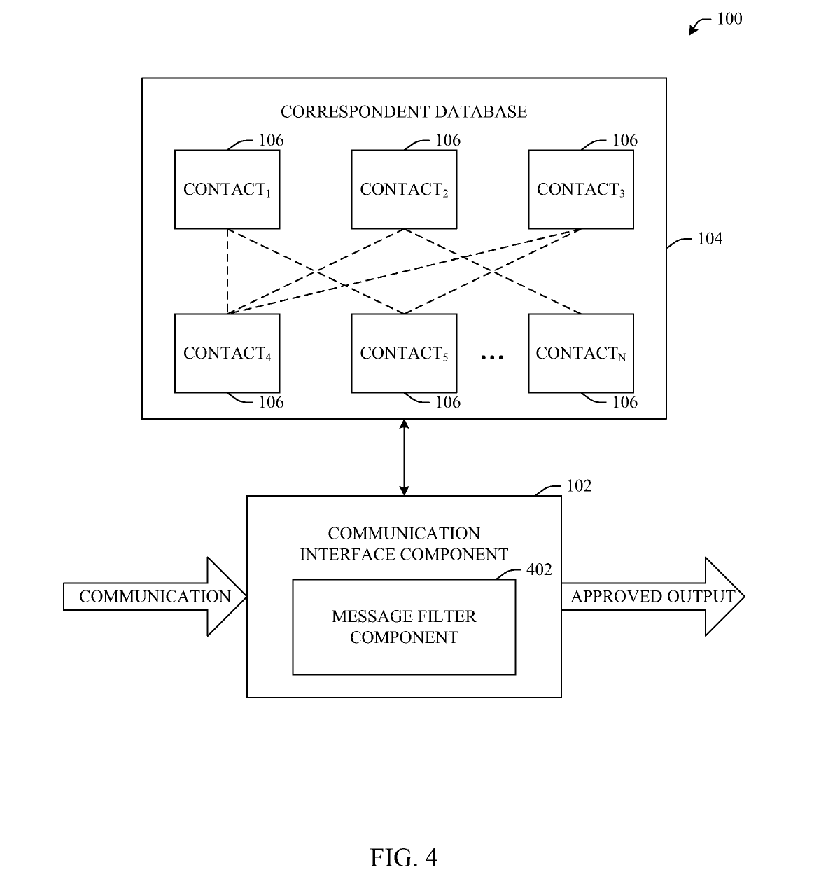

FIG. 4 illustrates an alternative block diagram of system 100 in accordance with the specification. More particularly, FIG. 4 illustrates a message filter component 402 included within the communication interface component 102. As briefly described above, the communication interface component 102 can be located within a network device (e.g., router, switch) whereby the communication can be effectively filtered (e.g., allowed or denied). In other aspects, the interface component 102 can be maintained within the receiving device itself. By way of example, the interface component 102 can be maintained within a client device such as a personal computer (PC), laptop/notebook computer, mobile phone, personal digital assistant (PDA), personal music player, etc. In either of these examples, the correspondent database 104 can be co-located within the device, distributed throughout the network or any combination therewith.

The message filter component 402 can be employed to manage determinations of acceptance and/or denial with regard to a received communication. For example, policy thresholds can be set by a user and incorporated into a policy used to accept and/or deny communication. This policy criterion can be most any desired criterion including, cross communication statistics, degree of separation statistics, message content limitations, etc. Still further, the message filter component 402 can consider context of the receiver as well as context of the sender in order to facilitate determination of acceptance and/or denial. By way of example, separate policy thresholds can be used to permit or deny communication based upon a receiver context such as, location, activity engaged within, capacity (e.g., work, home), etc. Similarly, sender context can be employed by the message filter component to establish an acceptance/retention determination.

By way of example, a content filter can be used in conjunction with degrees of separation to deem some content from a particular sender as spam while allowing other useful communications. Similarly, a sender's context (e.g., at home on a Saturday night) can be used to effectively determine probability of spam communication. It will be appreciated that most any criterion can be gathered and/or maintained or used with other information maintained within the correspondent database 104 and likewise employed to establish an acceptance/retention determination.

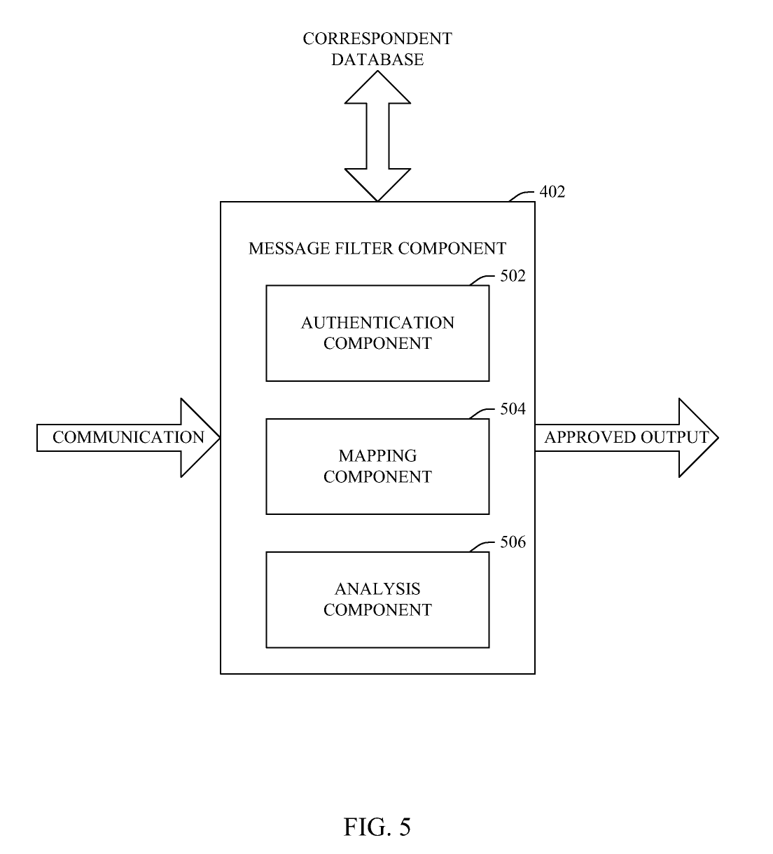

Referring now to FIG. 5, an example block diagram of message filter component 402 is shown. As illustrated, message filter component 402 can include an authentication component 502 that authenticates criteria of the sender. For example, the authentication component 502 can establish that a sender is who they purport to be, are sending from the domain they purport to be sending from, etc. Still further, as described above, most any authentication mechanisms known in the art can be employed to effectuate authentication. For instance, DKIM authentication can be employed to establish authentication.

Once authenticated, the mapping component 504 can be employed to locate the authenticated sender within the correspondent database 104. As well, the mapping component 504 can be employed to map the sender to other correspondents within the database. As illustrated, an analysis component 506 can be employed to determine if the correspondence should be accepted and/or denied.

The following example is included to add perspective to the specification. Thus, it is to be understood that other thresholds and/or criterion can be employed to establish an acceptance/retention determination without departing from the spirit and scope of the innovation. In the following example, the mapping component 504 can be used in conjunction with the analysis component 506 to determine the degrees of separation from trusted contacts. Accordingly, limits can be set to identify the acceptable threshold(s).

As described supra, the authenticated correspondent database (104 of FIG. 1) can be used to fairly quickly determine the status of a class of high volume domains with similar postures (e.g., wanted, unwanted). Additionally, the authenticated database (104 of FIG. 1) can be used to evaluate domains with little or emerging data, and domains for which there are plenty of data, but the data are conflicting. The latter is particularly relevant to large domains where there is large user base where the provider does not have very good control on the behavior of their users, such as large email service. In both of these scenarios, without the analysis component 506 there may be insufficient information to make the larger assertions. Therefore, the analysis component 506 can leverage the content of the correspondent database (104 of FIG. 1) to make inferences and predictions based upon other information to bias the ultimate disposition of the message.

The authenticated correspondent database need not contain only information about the correspondence in question, but also information about past correspondence of the user (e.g., sender, receiver). In situations where the overall reputation of a domain is either muddled in the case of a large email provider, or emerging in the case of a newly introduced domain, the analysis component 506 can mine the correspondent database for other user's experience associated to the correspondence or sender in question. In particular, it is likely to be the case that even if the data is too scant to make a larger assertion, if the degrees of separation between a known/trusted correspondent in the same domain is low then the likelihood of this being a new but acceptable introduction increases.

By specific example, suppose that mat@xyzcompany.com receives a piece of mail from sniglit@emailprovider.com. Unfortunately, there may too few previous hits to make a larger assessment as to whether sniglit@emailprovider.com is a good or bad actor. However, if mat@xyzcompany.com can determine that the degrees of separation between himself and sniglit@emailprovider.com were low, say less than, or equal to 3, then it might be worthwhile biasing the receiver toward reception rather than spam. In other words, if fred@xyzcompany.com had corresponded with barney@xyzcompany.com who had corresponded with sniglit@emailprovider.com, mat@xyzcompany.com may reasonably infer since the degree of separation is 3 that sniglit@emailprovider.com should be biased toward receipt rather than spam.

Additionally, it is to be understood that ‘strength’ of correspondence tuples can be considering in arriving at a spam determination. For example, if mat@xyzcompany.com regularly corresponds with fred@xyzcompany.com who regularly corresponds with barney@xyzcompany.com who is now corresponding with sniglit@emailprovider.com, there can be a much better indication that if mat@xyzcompany.com never corresponded with fred@xyzcompany.com.

It is to be understood that ‘correspondence’ used herein refers to all forms of correspondence (e.g., one-to-one, one-to-many, many-to-one and many-to-many), not just broadcasts from spammers to victims. Following the same reasoning, the opposite can also be true. For example, if within the allowable degrees of separation none of a user's correspondents have corresponded with the subject (e.g., sender), then filtering might be biased toward discarding rather than receiving.

The degrees of separation between the target of a message and known correspondents who have also communicated with the subject in question can provide useful receiver information, especially in the authenticated correspondent database (104 of FIG. 1) entries (e.g., tuples) with insufficient statistical relevance to make larger assertions. In particular, the use of the degrees of separation can be used as a bias toward receiving or discarding messages.

Essentially, with low fidelity statistics, a user can leverage early warnings based upon who they correspond with, who their contacts correspond with and so on. If people within an acceptable degree of separation choose to communicate with a new subject, biasing toward reception is likely to produce fewer false positives. Since un-introduced domains or users are by far the most likely to be bearers of spam, aggressive treatment is clearly an advantage.

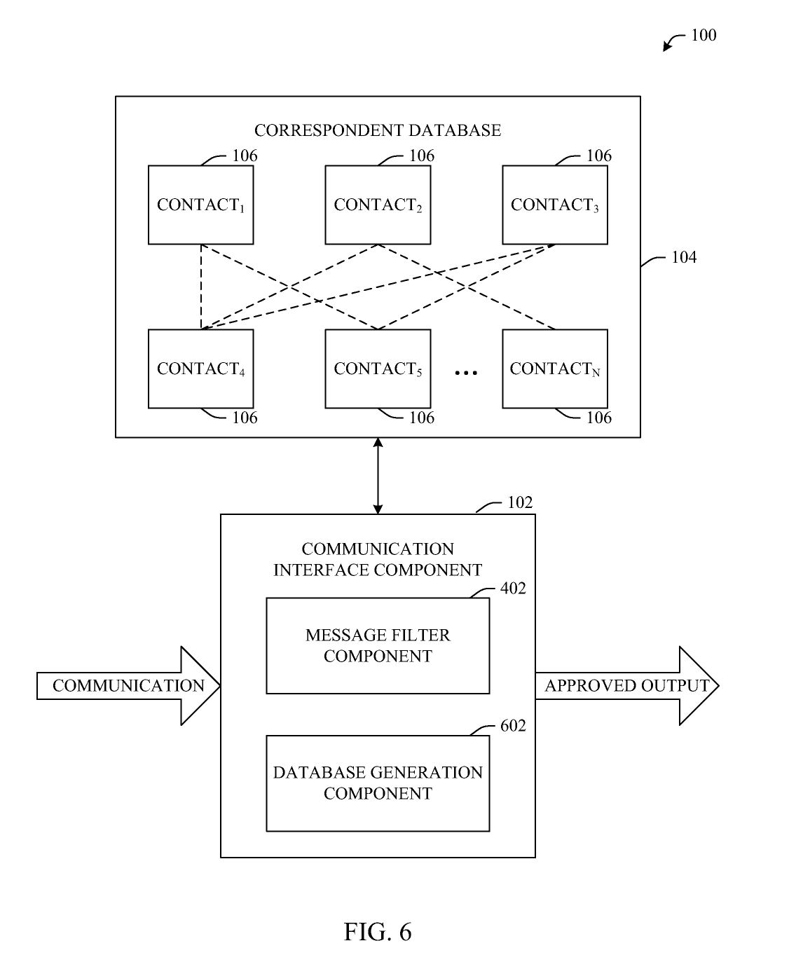

Turning now to FIG. 6, an alternative example architectural diagram of system 100 is shown. More particularly, as shown in FIG. 6, interface component 102 can include a database generation component 602 that automatically establishes and/or updates the correspondent database 104 as appropriate. Spam, more formally known as unsolicited commercial email, is frequently characterized by messages sent from entities which are sometimes known to the recipient, but usually are not. In an effort to drive down false positives with regard to classifying correspondence as spam, authentication efforts have been focused on providing domain level identification (e.g., DKIM) as well as mechanisms to identify the author or sender. Here, the database generation component 602 can employ these identities (together with other information such as context) to form a correspondent database 104.

It will be appreciated that authentication can lead to more accurate ‘white’ and ‘black’ biasing decisions since the email will be authenticated. One form of white listing traditionally performed even without authentication is to place an address onto a white list if the user chooses to correspond to them (either initially or in reply to a message from the sender). With authentication, this could even be scaled to a larger group, like an entire enterprise, and thus leverage a larger pool of experiences to determine whether an individual sender or the sending domain is likely to be a good actor or not.

While this sort of scheme is likely to be helpful, it is only as useful as the completeness of the database of known good or bad correspondents. Conventionally, these correspondents are only harvested from email conversations. Unfortunately, email is but one way for an introduction to be made. For example, a user might purchase an item from an online store which in turn sends a confirming email, or a user sends email to another with their session initiation protocol uniform resource identifier or embedded SIP URI who in turn calls their correspondent. This may lead to normal transactional mail or cross protocol use patterns to look suspicious, even though the larger picture would paint a better assessment.

In order for the database generation component 602 to create a more comprehensive correspondent database 104, it is particularly helpful to consider as many forms of solicited conversations from an individual or larger aggregate entity (e.g., a domain) across as many protocols as is practical to get a clearer picture of whether a given conversation is, in fact, solicited or unsolicited. Thus, web (e.g., HTTP (hypertext transport protocol)), telephony (SIP) and instant messaging (IM) could all contribute to the larger picture of whether a given domain or individual within a domain is known to the recipient(s). With this knowledge in hand, filtering software for the various protocols can more accurately know how to bias its disposition toward a sender, thus driving down false positives for known good senders and allowing more aggressive filtering on unknown sources.

In one aspect, the database generation component 602 can create and/or update the correspondent database 104 actively by the user software that initiates a conversation. In another aspect, the database 104 can be established passively by network infrastructure such as proxies and routers which have access to who initiated a conversation to whom. As well, other aspects combine these mechanisms to establish the correspondent database 104. Still further, a user can manually establish and/or modify the entries of the correspondent database 104 as desired.

As described above, the correspondent database 104 can be drawn from many different protocol sources such as simple mail transfer protocol (SMTP), HTTP, IM, SIP, etc. Thus, by enabling employment of multiple protocols, a more comprehensive view of known correspondents can be established. Therefore, the system 100 can more accurately classify known and unknown sources.

In order to establish the correspondent database 104, the database generation component 602 can track the specifics of correspondents in other domains. For example, the component 602 can employ counters to aggregate the number of correspondences as well as correspondence patterns. As described above, the information gathered and maintained within a correspondence database 104 can be used to drive down false positive rates for known good correspondents, provide more input into blacklisting and spam biasing decisions, etc.

In one example, a correspondent database 104 for email can include the following information:

our domain contact: mat@xyzcompany.com
their domain contact: mike@abccompany.com
Number of hits from our domain to their domain: 100
Number of hits from their domain to our domain: 76

This record of communication would likely establish that mike@abccompany.com and mat@xyzcompany.com frequently correspond. As well, the information establishes that abccompany.com is generally known to xyzcompany.com. As discussed supra, this information can be used to make intelligent and informed biasing decisions with regard to received communication(s). As a result, false positives can be driven down to increase accuracy of any white and black list type filtering.

While this is very useful information, there is also the possibility for misuse, as the actual correspondents can be very interesting information. Moreover, there are potentially serious privacy concerns with keeping the correspondent database 104 that includes explicit name tuples, not to mention the possibility for accidental disclosure.

Here, one main purpose of the correspondent database 104 is to track overall correspondence patterns. In other words, a correspondent database 104 that includes to/from tuples to track correspondence patterns is mainly interested in the patterns of communication itself, rather than the particulars of who corresponded with whom in any absolute sense. Thus, in one aspect, for the purposes of a correspondent database 104, the nodes need not be kept in a plain text form in order to provide the described utility of tracking overall correspondence patterns. Although, if desired, maintaining node identity is possible.

In an embodiment, a simple method to achieve some privacy in the correspondent database 104 can be to perform a simple one-way hash. This may be adequate in some situations, but may have an undesirable characteristic that chosen text (e.g., chambers@xyzcompany.com) could easily be constructed. To combat this, the correspondent database 104 could also maintain a secret cryptographic key. In operation, the key can be employed to perform a keyed hash over the plain text. In this case, an attacker would not only need the chosen text, but also access to the secret key in order to expose the information. It is to be understood that a one way hash or some other cryptographic transform can be performed on the input data to an authenticated correspondent database 104 to provide a layer of privacy against potential abuse while still retaining the utility of the correspondent database 104.

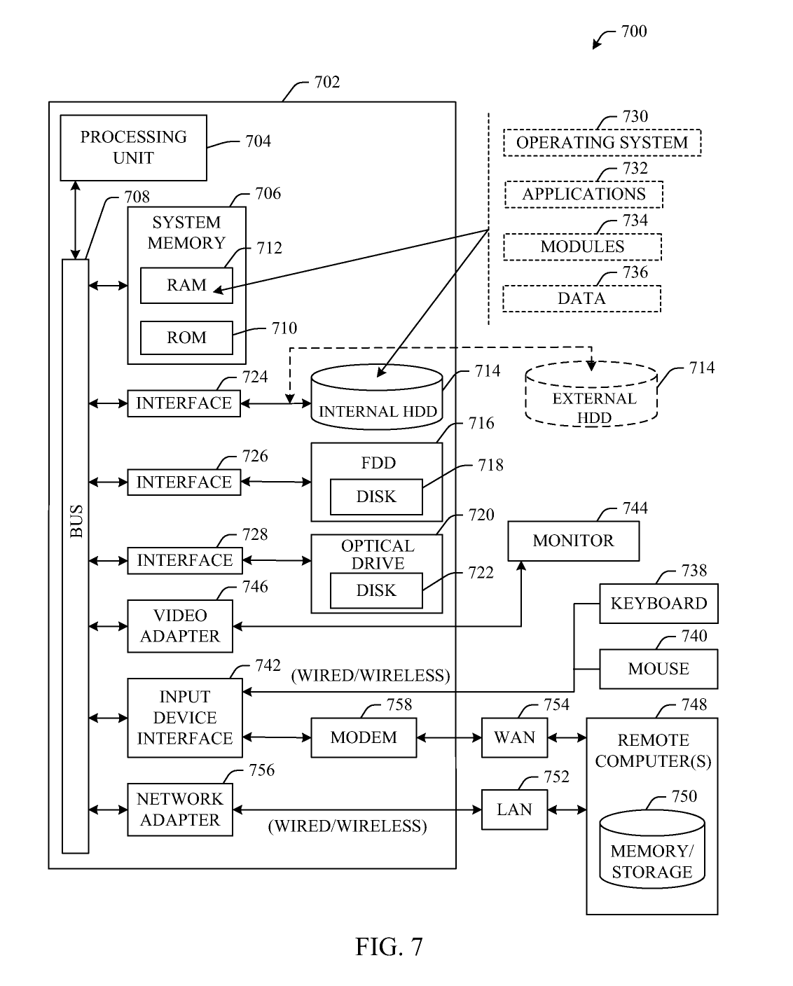

Referring now to FIG. 7, there is illustrated a block diagram of a computer operable to execute the disclosed architecture. In order to provide additional context for various aspects of the subject specification, FIG. 7 and the following discussion are intended to provide a brief, general description of a suitable computing environment 700 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 7, the exemplary environment 700 for implementing various aspects of the specification includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the specification.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the specification can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adapter 756 may facilitate wired or wireless communication to the LAN 752, which may also include a wireless access point disposed thereon for communicating with the wireless adapter 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

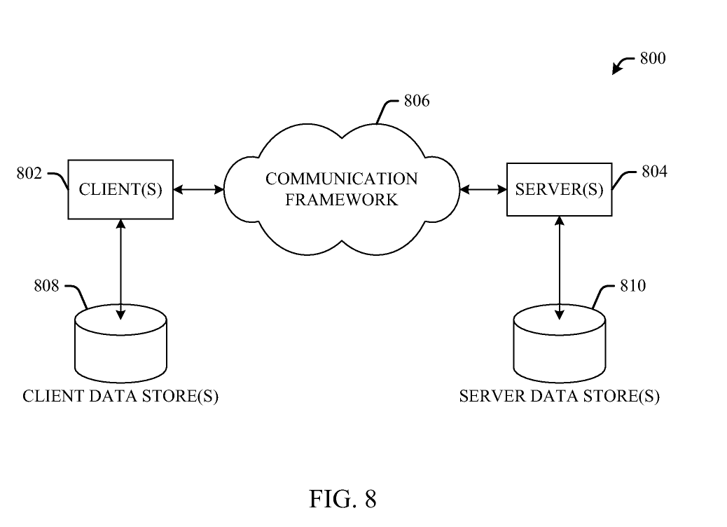

Referring now to FIG. 8, there is illustrated a schematic block diagram of an exemplary computing environment 800 in accordance with the subject specification. The system 800 includes one or more client(s) 802. The client(s) 802 can be hardware and/or software (e.g., threads, processes, computing devices). The client(s) 802 can house cookie(s) and/or associated contextual information by employing the specification, for example.

The system 800 also includes one or more server(s) 804. The server(s) 804 can also be hardware and/or software (e.g., threads, processes, computing devices). The servers 804 can house threads to perform transformations by employing the specification, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

What has been described above includes examples of the specification. It is, of course, not possible to describe every conceivable combination of components or methodologies for purposes of describing the subject specification, but one of ordinary skill in the art may recognize that many further combinations and permutations of the specification are possible. Accordingly, the specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates authentication of a sender, comprising:
a correspondent database that maintains relationship information between a plurality of contacts, wherein the relationship information defines a degree of separation between at least two contacts, wherein the correspondent database is drawn from at least one of a simple mail transfer protocol (SMTP), HTTP (hypertext transfer protocol), IM (instant messaging) protocols, Voice over IP (VoIP) protocols, or other protocols where the authenticity of an originator can be ascertained; and
a communication interface component that receives a communication from the sender and accepts or denies the communication as a function of the relationship information.

2. The system of claim 1, further comprising a communication message filter component that defines criteria that controls acceptance or denial of the communication, wherein the communication is at least one of an email, an instant message, a text message or a voice-over-internet-protocol (VoIP) message.

3. The system of claim 1, further comprising a correspondent authentication component that authenticates identity of the sender.

4. The system of claim 3, further comprising a mapping that maps the identity to a subset of the plurality of contacts, wherein the relationship information is defined by the mapping between the sender and the subset of the plurality of contacts.

5. The system of claim 4, further comprising an analysis component that analyzes content of the communication, wherein the communication interface component employs the analysis in acceptance or denial of the communication.

6. The system of claim 1, further comprising a contact classification component that facilitates establishment of the relationship information.

7. The system of claim 6, further comprising a correspondent authentication component that authenticates identity of the sender, wherein the contact classification component employs the identity to establish the relationship information.

8. The system of claim 7, further comprising a relationship analysis component that evaluates the identity of the sender as a function of relationship information associated to a subset of the contacts.

9. The system of claim 8, further comprising a tuple generation component that establishes a tuple that corresponds to the sender, wherein the communication interface component employs the tuple to accept or deny the communication.

10. The system of claim 9 wherein, the tuple includes at least one of identity of the sender, context of the sender, location of the sender or relationship information that defines correlation between a subset of the contacts as a function of the sender.

11. The system of claim 1, wherein the communication is at least one of an instant message, an email or a VOIP message.

12. A method, comprising:
receiving a communication from a sender;
authenticating identity of the sender; and
accepting or denying the communication as a function of an association of the sender to a plurality of contacts.

13. The method of claim 12, further comprising:
establishing a database tuple that corresponds to identity wherein the database tuple includes association information that associates the sender to a subset of the plurality of contacts; and
analyzing the database tuple as a function of a policy that defines acceptance or denial of the communication as a function of the association information.

14. The method of claim 13, further comprising establishing the policy that controls determination of acceptance or denial of the communication.

15. The method of claim 12, further comprising.
analyzing content of the communication and employing the content when accepting or denying the communication.

16. The method of claim 12, the communication is one of an instant message, an email or a VOIP message.

17. An apparatus, comprising:
means for managing a plurality of relationships between a plurality of contacts, wherein identity of each of the plurality of contacts is maintained in privacy;
means for authenticating identify of a sender of a message; and
means for accepting or rejecting the message based upon the identity as a function of a subset of the plurality of relationships.

18. The system of claim 17, further comprising means for establishing the plurality of relationships between a plurality of contacts.

19. The system of claim 17, further comprising means for updating the plurality of relationships based at least in part upon a result established by the means for accepting or rejecting the message.

20. The system of claim 17, further comprising:
means for establishing context; and
means for incorporating the context into the means for accepting or rejecting the message.
